(19) United States
(12) Patent Application Publication
(10) Pub. No.: US 2016/0047296 A1
(43) Pub. Date: Feb. 18, 2016

(54) Mechanism For Varying Crankshaft Timing On A Belt/Chain Driven, Dual Crankshaft Opposed-Piston Engine

(71) Applicant: ACHATES POWER, INC., San Diego, CA (US)

(72) Inventors: Fabien G. Redon, SAN DIEGO, CA (US); GARY A. VRSEK, HOWELL, MI (US)

(73) Assignee: ACHATES POWER, INC., San Diego, CA (US)

(21) Appl. No.: 14/779,490

(22) PCT Filed: Apr. 7, 2014
(86) PCT No.: PCT/US14/33151

§ 371 Date: Sep. 23, 2015

Related U.S. Application Data
(60) Provisional application No. 61/810,256, filed on Apr. 9, 2013.

(51) Int. Cl. F02B 25/08; F02B 75/28; F16H 7/12

(52) U.S. Cl. CPC F02B 25/08; F16H 7/1281; F02B 75/282

(57) ABSTRACT

A mechanism for varying crankshaft timing on a belt/chain driven, dual crankshaft opposed-piston engine includes sprockets on corresponding ends of the two crankshafts, connected by a belt or chain which is tensioned by two or more tensioners. By changing the position of the tensioners the length of the two spans of the belt/chain are varied and thus the phase between the crankshafts is varied.

### PRIORITY

This application claims the benefit of and priority to U.S. application 61/810,256, filed in the US Patent and Trademark Office on 9 Apr. 2013.

### BACKGROUND

The subject matter relates to a dual-crankshaft, opposed-piston engine with improvements for variable port timing. More particularly, the subject matter relates to an opposed-piston engine with two crankshafts coupled by a belt or chain, in which a timing control mechanism acts against the belt or chain to vary the timing of port operations in the engine.

In an opposed-piston engine, a pair of pistons is disposed for opposed sliding motion in the bore of at least one ported cylinder. Each cylinder has exhaust and intake ports, and the cylinders are juxtaposed and oriented with exhaust and intake ports mutually aligned. Each port is constituted of one or more arrays or sequences of openings disposed circumferentially in the cylinder wall near a respective end of the cylinder. The engine includes two crankshafts rotatably mounted at respective exhaust ends and intake ends of the cylinders, and each piston is coupled to a respective one of the two crankshafts, In a belt (or chain)-driven, dual crankshaft, opposed-piston engine, the two crankshafts are connected by a belt or chain. The reciprocal movements of the pistons control the operations of the ports. In this regard, each port is located at a fixed position where it is opened and closed by a respective piston at predetermined times during each cycle of engine operation. Those pistons that control exhaust port operation are termed ‘exhaust pistons’ and those that control intake port operation are called “intake pistons”.

Typically in opposed-piston engines the exhaust piston is phased in relation to the intake piston so as to enhance exhaust gas purging and scavenging during the later portion of the power stroke.

Piston phasing is normally fixed by positioning the exhaust piston connecting rod at some advanced angle on the crankshaft to which it is connected (“the exhaust crankshaft”) ahead of the intake piston connecting rod position on the crankshaft to which it is connected (“the intake crankshaft”). In such a configuration, as the pistons move away from top center (TC) positions after combustion, both ports (intake and exhaust) are closed by their respective pistons. As the pistons approach bottom center (BC) positions the exhaust port is opened first to begin exhaust gas purging and then the intake port opens some preset time later to allow pressurized air into the cylinder chamber to provide scavenging of the remaining exhaust gasses. As the pistons reverse direction, the exhaust port closes first, allowing pressurized air into the cylinder chamber through the still open intake port until it too closes and a compression cycle begins.

It is desirable to be able to control port phasing in an opposed-piston engine by relying on changing piston phasing in such a way as to dynamically adapt port opening and closing times to changing speeds and loads that occur during engine operation.

### SUMMARY

This desirable objective is achieved in a belt (or chain)-driven, dual crankshaft, opposed-piston engine by tensioning, the belt or chain that connects the two crankshafts by two or more tensioners. By changing the position of the tensioners, the lengths of two spans of the belt/chain are varied and thus the phase between the crankshafts is varied, Varying the phase between the crankshafts, in turn, varies the inter-piston phasing, thereby changing port phasing.

### BRIEF DESCRIPTION OF THE DRAWINGS

FIG. 1 is a schematic diagram of a dual crankshaft opposed-piston engine.

FIGS. 2A-2C are schematic illustrations of an interlinked crankshaft system of a belt/chain drive, dual crankshaft, opposed-piston engine in which the two crankshafts are connected by a belt or chain engaged by two idlers, showing variable crankshaft phasing.

FIGS. 3A-3C are schematic illustrations of an interlinked crankshaft system of a belt/chain drive, dual crankshaft, opposed-piston engine in which the two crankshafts are connected by a belt or chain engaged by four idlers, showing variable crankshaft phasing.

FIG. 4 is a schematic illustration of an interlinked crankshaft system for a belt/chain drive, dual crankshaft, opposed-piston engine showing output shaft integration for the multi-idler configurations of FIGS. 2A-2C

FIG. 5 is a schematic illustration of an interlinked crankshaft system for a belt/chain drive, dual-crankshaft, opposed-piston engine showing output shaft integration for the multi-idler configurations of FIGS. 3A, 3B, and 3C.

### SPECIFICATION

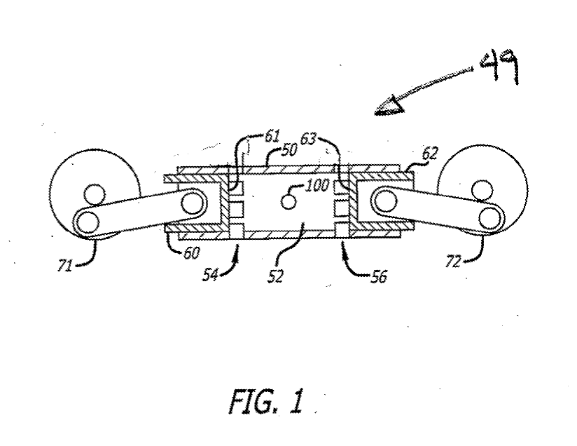

FIG. 1 illustrates a dual crankshaft opposed-piston engine 49 having at least one ported cylinder 50. For example, the engine may have one ported cylinder, two ported cylinders, three ported cylinders, or four or more ported cylinders. Each cylinder 50 has a bore 52 and exhaust and intake ports 54 and 56 formed or machined in respective ends thereof. The exhaust and intake ports 54 and 56 each include one or more circumferential arrays of openings in which adjacent openings are separated by a solid bridge. In some descriptions, each opening is referred to as a “port”; however, the construction of a circumferential array of such “ports” is no different than the port constructions shown in. FIG. 1. Exhaust and intake pistons 60 and 62 are slidably disposed in the bore 52 with their end surfaces 61 and 63 opposing one another, The exhaust pistons 60 are coupled to a crankshaft 71, the intake pistons are coupled to the crankshaft 72. Although the figure shows the engine 49 in an essentially vertical orientation, this is for the sake of illustration only; in other aspects the engine could be disposed in other orientations than the vertical one shown.

When the pistons 60 and 62 of a cylinder 50 are at or near their TC positions, a combustion chamber is defined in the bore 52 between the end surfaces 61 and 63 of the pistons. Fuel is injected directly into the combustion chamber through at least one fuel injector nozzle 100 positioned in an opening through the sidewall of a cylinder 50.

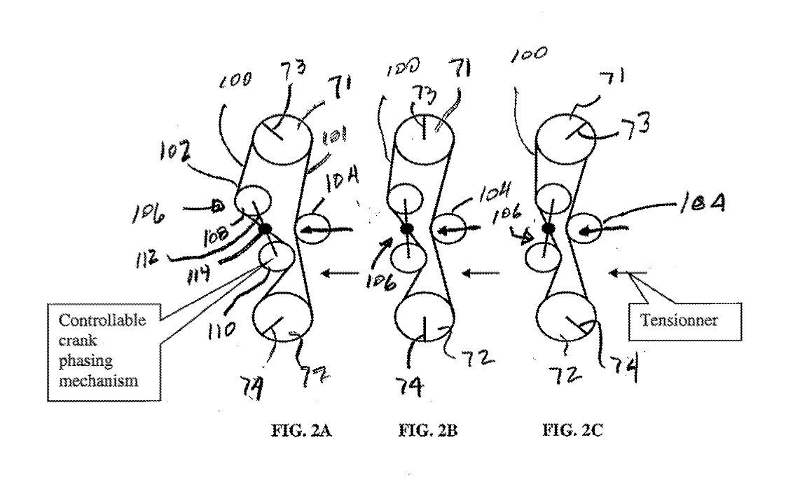

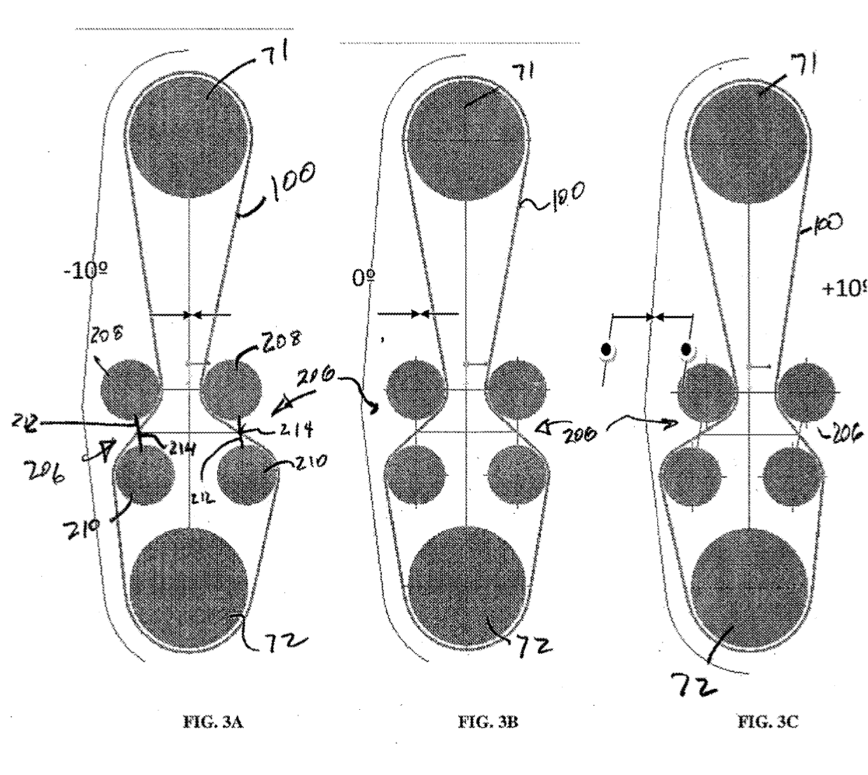

FIGS. 2A-2C and 3A-3C show a dual crankshaft, opposed-piston engine, such as that shown in FIG. 1, equipped with a belt (or chain) 100 that couples the crankshafts 71 and 72. The belt 100 is engaged by spaced-apart tensioning idlers that are disposed on respective sides of a straight line connecting the axes of the crankshafts. The phasing between the crankshafts 71 and 72 is varied by controlling the movement of the tensioning idlers so as to vary the tension in the belt 100. By changing the positions of the tensioners, the lengths of two spans of the belt are varied and thus the phase between the crankshafts is varied. Varying the phase between the crankshafts, in turn, varies the inter piston phasing, thereby changing port phasing of the opposed-piston engine 49.

As seen in FIGS. 2A-2C, a tensioning idler 104 acts against a first span of the belt 100 and is spring-loaded in one direction indicated by the arrow so as to take up any slack in the belt 100. A second tensioning idler 106 acts against a second span of the belt 100. The second tensioning idler 106 is constituted of a pair of pulleys 108, 110 mounted at opposing ends of a pulley arm 112 pivoted at a point 114 fastened to the engine structure. The pulleys are in rolling contact with opposite sides of the second span of the belt 100. The pulley arm 112 is controlled by an actuator to pivot from one position to another in a predetermined arc. As the pulley arm 112 is pivoted, the pulleys 108 and 110 swing in opposing CW/CCW directions, thereby changing the length of travel of the belt 100. The changes in the length of travel cause the phase between the crankshafts to shift as indicated by the changes in position of the crankshaft timing lines 73 and 74.

As seen in FIGS. 3A-3C, two tensioning idlers 206 act against respective spans of the belt 100. Each of the tensioning idlers 206 is constituted of a pair of pulleys 208, 210 mounted at opposing ends of a pulley arm 212 pivoted at a point 214 fastened to the engine structure. The pulleys are in rolling contact with opposite sides of the respective spans of the belt 100. Each of the pulley arms 212 is controlled by an actuator to pivot from one position to another in a predetermined arc, As a pulley arm 212 is pivoted, the pulleys 208 and 210 swing in opposing CW/CCW directions, thereby changing the length of travel of the belt 100. The changes in the length of travel cause the phase between the crankshafts to shift.

With the layout shown in FIGS. 3A-3C, a belt tensioning idler 206 only needs to compensate for belt stretch and to maintain the tension. A shorter tensioning idler motion range facilitates the design of this component. The belt tension would be exercised between one side of the belt 100 and the other. instead of between the engine block and the belt 100 as in the embodiment of FIGS. 2A-2C.

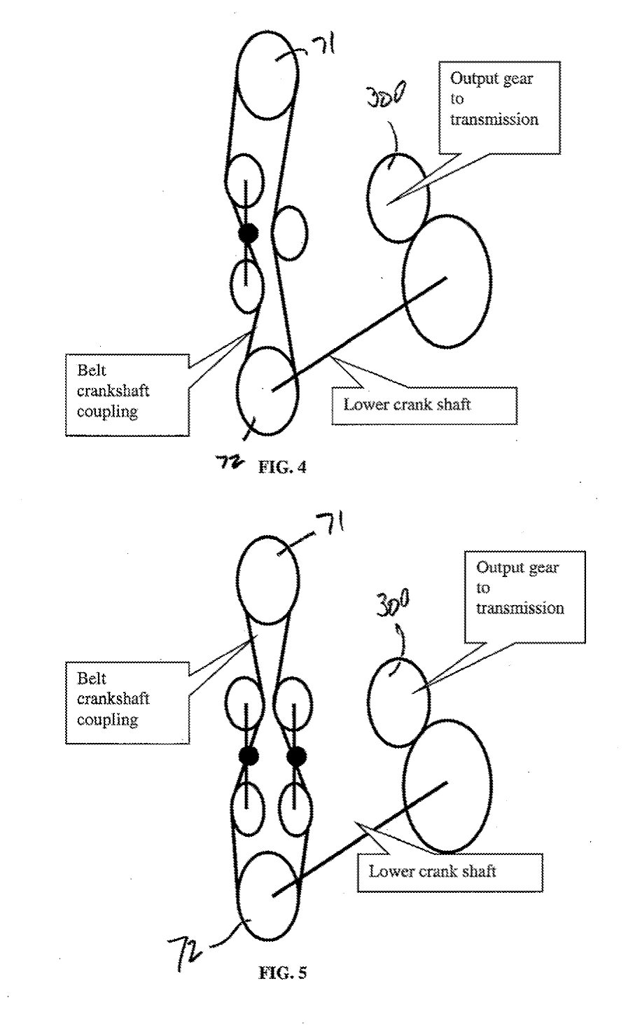

Output shaft integration for the belt/chain drive, dual crankshaft embodiment of FIGS. 2A-2C is shown in FIG, 4, and output shaft integration for the belt/chain drive, dual crankshaft embodiment of FIGS. 3A-3C is shown in FIG. 5. Both of these figures presume that the crankshaft 71 is disposed above the crankshaft 72, and so, for the purposes of these figures, the crankshaft 72 is referred to as the “lower” crankshaft. With each embodiment the belt drive is located on the opposite end from where the engine is connected to the crankshaft, allowing for easy belt replacement if necessary. In some aspects, if the engine power was connected to the lower crankshaft 72, the engine would sit too high and would not package well. However, as per FIGS. 4 and 5, the output is taken from a gear idler 300 connected to the lower crankshaft 72 which allows the engine to sit at the proper height and clear the vehicle components above the engine.

This last gear set before the transmission can be manipulated to adjust the output shaft speed with respect to the crankshaft of the engine allowing for further integration flexibility with the vehicle.

1. A dual-crankshaft, opposed-piston engine (49), including one or more ported cylinders (50) that are juxtaposed and oriented with exhaust (54) and intake (56) ports mutually aligned, a pair of crankshafts (71, 72), each rotatably mounted at respective exhaust and intake ends of the cylinders, a pair of pistons (60, 62) is disposed for opposed sliding movement in the bore (52) of each cylinder, all of the pistons (60) controlling the exhaust ports (54) being coupled by connecting rods to the crankshaft (71) mounted at the exhaust ends of the cylinders, and all of the pistons (62) controlling the intake ports (56) being coupled by connecting rods to the crankshaft (72) mounted at the intake ends of the cylinders, characterized in that:
the two crankshafts (71, 72) are connected by a belt or chain (100), with opposing tensioning idlers (104, 106), (206) operatively engaging opposing lengths of the belt or chain, and at least one tensioning idler includes a pair of pulleys (108, 110), (208, 210) mounted at opposing ends of a centrally-pivoted pulley arm (112), (212).

2. The dual crankshaft, opposed-piston engine of claim 1, in which:
the tensioning idlers are disposed on respective sides of a straight line connecting the axes of the two crankshafts
a first tensioning idler (104) acts against a first span of the belt or chain (100) and is spring-loaded in a first direction so as to take up any slack in the belt 100;
a second tensioning idler (106) acts against a second span of the belt or chain (100); and
the second tensioning idler is constituted of a pair of pulleys (108, 110) mounted at opposing ends of a pulley arm (112) pivoted at a point (114) fastened to the engine structure.

3. The dual crankshaft, opposed-piston engine of claim 2, in which the pulleys (108, 110) are in rolling contact with opposite sides of the second span of the belt (100).

4. The dual crankshaft, opposed-piston engine of claim 1, in which:
the tensioning idlers (206, 206) are disposed on respective sides of a straight line connecting the axes of the two crankshafts
each tensioning idler (206) acts against a respective span of the belt or chain (100); and,
each tensioning idler is constituted of a pair of pulleys (208, 210) mounted at opposing ends of a pulley arm (212) pivoted at a point (214) fastened to the engine structure.

5. The dual crankshaft, opposed-piston engine of claim 4, in which the pulleys (208, 210) of each tension idler (206) are in rolling contact with opposite sides of a respective span of the belt or chain (100).

6. The dual crankshaft, opposed-piston engine of claim 1, in which the crankshafts include an upper (71) and a lower (72) crankshaft, and output to a transmission is taken from a gear idler (300) connected to the lower crankshaft.

7. The dual crankshaft, opposed-piston engine of claim 6, in which the gear idler (300) is connected to an end of the lower crankshaft (72) that is opposite to the end where the belt or chain (100) is connected.

8. A method for varying the timing of port operations of the dual crankshaft, opposed-piston engine of any one of claims 1-7 by pivoting at least one pulley arm (112, 212) from one position to another in a predetermined arc to thereby change the length of travel of the belt (100).
